(19) United States
(12) Patent Application Publication
(10) Pub. No.: US 2008/0066692 A1
(43) Pub. Date: Mar. 20, 2008

(54) Actuatable Toys

(75) Inventors: Klaus Woltmann, Demarest, NJ (US); Peter Ragonetti, Brooklyn, NY (US); Jonathan Willinger, Tenafly, NJ (US)

Correspondence Address: KATTEN MUCHIN ROSENMAN LLP, 575 MADISON AVENUE, NEW YORK, NY, 10022-2585, US

(73) Assignee: JW PET COMPANY, INC., Teterboro, NJ (US)

(21) Appl. No.: 11/856,845

(22) Filed: Sep. 18, 2007

Related U.S. Application Data
(60) Provisional application No. 60/845,410, filed on Sep. 18, 2006.

(51) Int. Cl. A01K 29/00

(52) U.S. Cl. 119/707

(57) ABSTRACT

An actuatable toy is operative to generate sound and other entertaining effects in response the bird's actions at one location of the toy, yet the effect being created at a second location. Thus, an indirect effect is created by the actuatable toy.

### RELATED APPLICATIONS

This application is the non-provisional counterpart application to and claims priority from U.S. Ser. No. 60/845,410, which is pending, which was filed on Sep. 18, 2006, and which is hereby incorporated by reference for all purposes.

### BACKGROUND OF THE INVENTION

1. Field of the Invention

The invention relates to interactive pet toys and particularly to toys actuatable by pets.

2. Description of the Related Art

Birds are emotional and curious creatures that need mental stimulation. For example, a bird in a bad mood pecks at the owner, when hours earlier it would be rubbing up against the owner and taking food from him. In the wild, birds have plenty of excitement and entertainment. In a cage, however, there is very little in the way of resource material for avian mental stimulation, and caged birds may sit aimlessly for hours on a perch.

Such sedentary behavior of the bird also negatively affects the bird owner, who wishes for his or her companion to be happy and healthy and who derives enjoyment in watching his or her charge playing and/or being entertained.

There is a need, therefore, for toys that are interesting and stimulating to birds and equally interesting and stimulating to bird owners. Therein, toys directed at birds treat birds as having “bird brains.” These toys tend to be simple and require birds to peck or manipulate them directly.

However, many bird species, contrary to unkind popular belief, are relatively intelligent creatures and direct action toys may not be sufficiently interesting. Thus, a need exists for toys that are interesting and stimulating to birds and equally interesting and stimulating to bird owners and may be more complex than direct action toys.

A further need exists for actuatable toys that are functionally and structurally coupled to a perch so that an owner may view the bird playing with the toy most easily.

### SUMMARY OF THE INVENTION

A device configured in accordance with the present disclosure meets these needs. The disclosed device has an interactive structure operative to generate various entertaining indirect effects in response to the action by a bird at location distant from the effect.

The effects produced by the actuatable device allow for repetitive actions by the bird at first location and entertain the bird positively contributing to its mental and physical health by showing the effects at a second location. Therein, the bird may not immediately perceive its action as contributing to the effect.

In accordance with one aspect of the disclosure, the disclosed device includes a bird-supporting structure, an actuator at a first location coupled to a sound generating unit at a second location relative to the supporting structure. Specifically, a bird grabs the actuator on the perch and actuates the sound generating unit that is disposed below the perch in response to a force applied to the actuator by the bird.

The bird-supporting structure is configured as an elongated perch shaped and dimensioned to resemble a branch or bow of tree and provide a comfortable support for the bird. Providing the perch with the actuator allows the bird to play with the actuator and be entertained by sound signals or other entertaining effects while the bird spends long hours sitting on the perch.

The actuator is configured with an elongated flexible body and selected from, among others, a chain, cord, rope, and elastic band. The actuator, thus, has two opposite ends one of which is coupled to the sound generating unit, and the other end is located near the perch so as to attract the bird's attention. In the normal position of the actuator, the sound generated unit is deactivated. Only upon application of a force to the end of the actuating device located near the perch, the sound is generated.

In accordance with one embodiment, the disclosed device has a mounting unit coupled to the perch and configured to support the sound generating device and the actuator. The mounting unit is removably mounted to the proximal end of perch and has a guide channel for receiving and guiding the end portion of the actuator in a manner that allows the bird to limitlessly pull the end of the actuator without applying a great force. The guide channel is configured to provide the end portion of the actuator with linear motion through the body of the mounting unit which helps the caged bird operate the disclosed toy in a smooth manner.

In accordance with a further embodiment, the above-disclosed actuator and mounting unit are utilized in combination with a displaceable element configured to attract the bird's attention. The actuator is operative to translate a pulling force applied by the bird while it is perched to the displaceable unit capable of entertaining the bird.

In accordance with another embodiment, the bird supporting structure further has an auxiliary entertaining unit removably coupled to the perch. The entertaining unit may be configured with a cord suspended on a supporting structure and configured so that the bird may grab it while sitting on the perch. In a further embodiment, the auxiliary entertaining unit is configured with a mirror located so as to reflect the bird's image. The auxiliary entertaining unit is located at such a distance from the proximal end of the perch that, when the bird is bored with playing the actuator causing a variety of entertaining effects, it may find a different perching position and play with the auxiliary entertaining unit.

The above and other features of the present disclosure will be further discussed in greater detail in conjunction with the following drawings.

### BRIEF DESCRIPTION OF THE DRAWINGS

FIG. 1 is a perspective view of one embodiment of an actuatable toy;

FIG. 2 is an exploded perspective view of the actuatable toy of FIG. 1;

FIG. 3 is an elevated side view of a mounting unit of FIGS. 1 and 2;

FIG. 4 is an exploded perspective view of another embodiment of the actuatable toy;

FIGS. 5 and 6 are respective perspective and side elevational views of another embodiment of the actuatable toy;

FIGS. 7 and 8 are perspective and side elevational views of still another embodiment of the actuatable toy;

FIG. 9 is a perspective view of yet another embodiment of the actuatable toy;

FIG. 10 is a perspective view of yet another embodiment of the actuatable toy;

FIG. 11 is a perspective view of a further embodiment of the actuatable toy configured to provide a mirror with displacement in response to a force applied by the bird to an actuator;

FIGS. 12 and 13 are respective perspective views of still another embodiment of the actuatable toy;

FIGS. 14 and 15 are respective perspective and side elevational views of a further embodiment of the actuatable toy;

FIGS. 16 and 17 are respective perspective and side elevational views of still another embodiment of the disclosed toy.

### DETAILED DESCRIPTION OF THE INVENTION

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “attach,” “connect,” “couple,” and similar terms with their inflectional morphemes do not necessarily denote direct and immediate connections, but also include connections through mediate elements or devices.

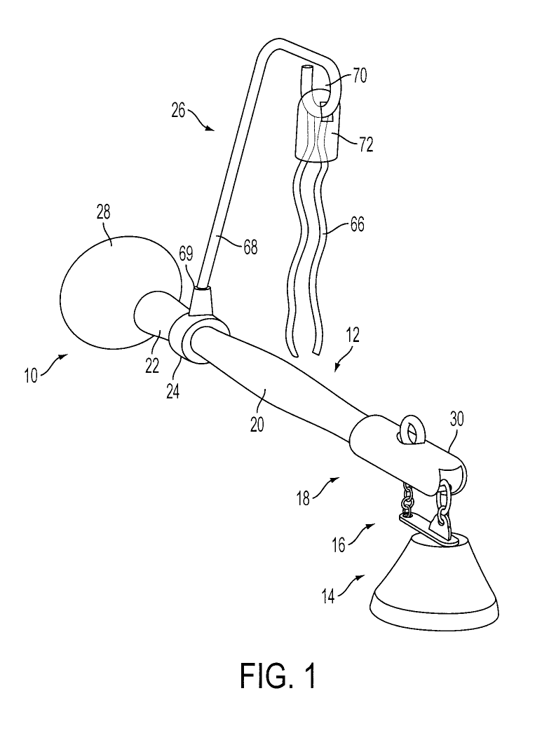

FIG. 1 shows an actuatable toy 10 configured with a perch 12, sound generating device 14, actuator 16, and a mounting unit 18 for coupling sound generating device 14 and actuator 16 to one another near perch 12. The sound-generating device 14 is operative to produce a sound signal in response to a pulling force applied to actuator 16 by the bird while the bird is sitting on perch 12.

The perch 12 is made from wood or plastic and has an elongated body that may be configured to have a variety of shapes dimensions. As illustrated in FIG. 1, the body of perch 12 has a medial and distal portions 20 and 22, respectively, defining therebetween a relatively small cylindrical body portion which is configured to support a mounting sleeve 24 of an auxiliary entertaining unit 26. The proximal end of perch 12 is engaged by mounting unit 18 as will be explained below. The actuatable toy 10 is mounted to a birdcage by means of a ribbed, i.e. knurled, nut and washer system 28 coupled to distal end 22 of perch 12 as for example taught with respect to U.S. Pat. Nos. 6,684,818 and 7,111,583, which are hereby incorporated by reference for all purposes.

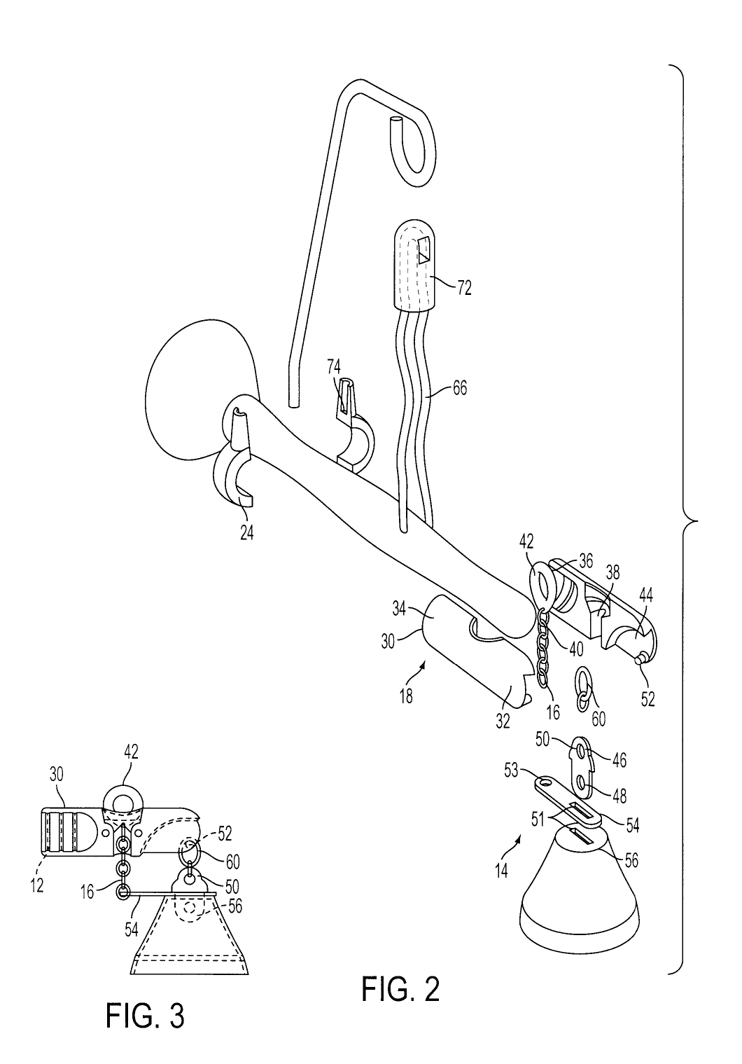

Referring to FIGS. 2 and 3 in addition to FIG. 1, mounting unit 18 has two collars 30 shaped to surround the proximal end of perch 12 in an assembled position of mounting unit 18. The collars 30 can be coupled, for example, by a fastener extending through both collars and configured as a screw or a bolt and nut unit. Alternatively, the engagement between collars 30 may be realized by one or multiple pins or formations configured to snap onto one another in response to an external force applied by the operator. In accordance with a further embodiment, collars 30 may be simply clamped or glued to the proximal end of perch 12.

During assembly of collars 30, the proximal end of perch 12 does not extend along the entire length of collars 30. Rather, distal ends 34 of respective collars 30 each have a seat 36 configured so that when the collars 30 are coupled together seats 36 define a space receiving the proximal end of perch 12, the peripheral surface of which is reliably engaged by respective inner surfaces of seats 36. As a result, in the assembled state, mounting unit 18 may receive the proximal end of perch 12 only in the desired position in which collars 30 can join one another as shown in FIG. 1.

The intermediary portions of respective collars 30, which are located beyond the proximal end of perch 12 after mounting unit 18 is assembled, each are configured with a passage 38. In the assembled state of mounting unit 18, passages 38 define a space traversed by an end 40 of actuator 16. While end 40 is freely displaceable within juxtaposed passages 38, an engagement unit 42 attached to end 40 of actuator 16 and projecting above collars 30 in the assemble state of mounting unit 18 is prevented from slipping or falling down through this space.

The engagement unit 42 may have limitless configurations including, for example, a ring as shown in FIGS. 1 and 2. The ring or engagement unit 42 is also dimensioned to be comfortably grabbed by the caged bird and preferably made from translucent plastic colored to attract the bird's attention.

Proximal ends 32 of respective collars 30 each have an indentation 44 structured to define a rear pocket in the assembled state of mounting unit 18. One of collars 30 is provided with a pin 52 receivable in an opening (not shown) which is formed in other collar 30 and dimensioned to receive pin 52 upon coupling collars 30. The pin 52 provides a support for sound generating unit 14 that is rotatably suspendable to pin 52, as disclosed below.

The sound generating unit 14 has a modular or one-piece structure including an engaging component 60 coupleable to pin 52 of mounting unit 18, mounting tab 46 attachable to engaging component 60, bell tab 54 coupled to actuator 16 and bell 56 coupled to both tabs 54 and 60. The mounting tab 46 has upper and lower halves 48 each provided with a hole 50.

In the assembled state of unit 18, a central opening of engaging element 60 is traversed by pin 52 of mounting unit 18 while the lower extremity of element 60 is threaded through hole 50 of upper half 48 of mounting tab 46. The lower half 48 of mounting tab 46 extends through aligned slits 51 of bell tab 54 and bell 56, respectively. The bell tab 54 extends generally perpendicular to mounting tab 46 and has an opening 53 spaced from slit 51 of bell tab 54 and engaging the low end of actuator 16.

When the caged bird, sitting on perch 12, applies a pulling force to engagement unit 42 that is located at one location relative to the perch, actuator 16 translates the pulling force into a torque applied to the end of bell tab 54 at a distant location relative to the perch, i.e. the underside. As a result, bell 56 starts pivoting about engaging element 60 to generate a sound signal that attracts the bird's attention; yet, the bird may not easily perceive the interaction.

Once the pulling force is ceases, bell 56 swings back bringing actuator 16 with engagement unit 42 which returns to its initial position next to perch 12. The actuator 16 includes any flexible element, which, for example, may be a chain made from metal or plastic.

The mounting unit 18 may be modified and instead of being a separate element detachably coupleable to perch 12, it may be an integral part of the perch. Furthermore, the proximal end of perch 12 may be provided with a throughgoing passage dimensioned to receive actuator 16 and provide an additional guide for the actuator. In either case, the location of the portion being explored, i.e. used, by the bird and the sound producing member is distant from each other to provide the bird an experience that direct action toys do not provide.

The actuatable toy 10 may be further provided with auxiliary entertainment unit 26 (FIG. 1) mounted close to the distal end of perch 12 by mounting sleeve 24. The auxiliary entertainment unit 26 is configured with a substantially L-shaped arm 68 having a hook-like upper end 70 that receives a supporting element 72 of wires 66. The supporting element 72 is pivotally mounted to upper end 70 of arm 68 and, thus, can swing in response to a force applied by the caged bird to wires 66. The lower end 69 of arm 68 is received in a passage defined between indentations 74 (FIG. 2) each provided in a respective one of detachably coupled collars of mounting sleeve 24.

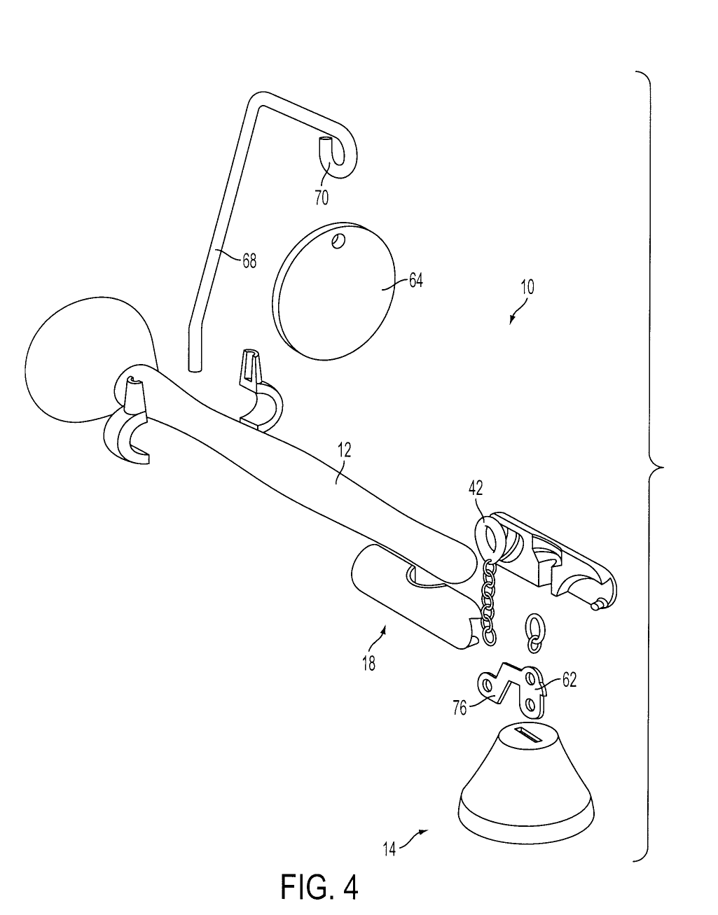

Referring to FIG. 4, actuatable toy 10 is configured substantially similar to the toy of FIGS. 1 and 2. However, the toy, as shown in FIG. 4, has sound generating unit 14 configured differently from the one illustrated in FIGS. 1-3. The sound generating unit has a one-piece mounting tab 62 one portion of which is configured similar to mounting tab 46 of FIGS. 1 and 2, and the other portion 76 has a step-like configuration. Portion 76 has one of its ends extending from the upper half of tab 62 and the other end coupled to actuator 16.

The actuator 16 and tab 62 are so dimensioned that the bell of sound generating unit 14 extends along a symmetry axis that is substantially perpendicular to the longitudinal axis of perch 12 in the normal position of sound generating unit 14. Such a configuration facilitates actions of the caged bird assuring that engagement unit 42 returns to its predetermined initial position next to perch 12.

Similar to the prior embodiment, the location of the portion being explored, i.e. used, by the bird and the sound producing member is distant from each other to provide the bird an experience that direct action toys do not provide.

The auxiliary entertainment unit 26 provided on toy 10 of FIG. 4 has a mirror 64 pivotally mounted to hook-shaped end 70 of arm 68. The caged bird may touch mirror 64 that starts swinging in response to the bird's touch.

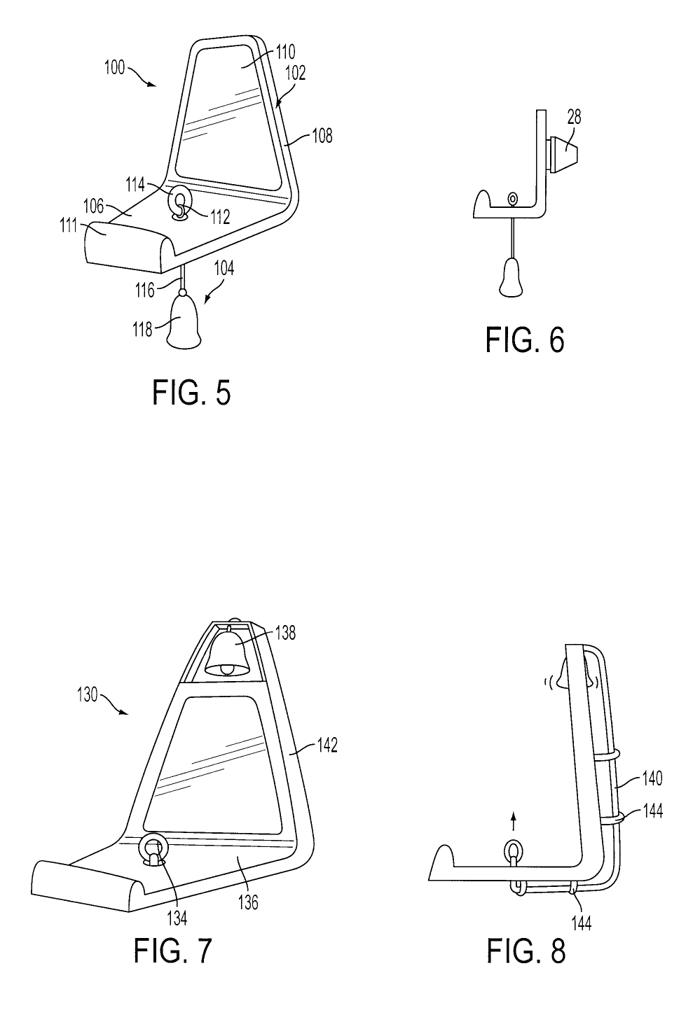

FIGS. 5-10 illustrate further embodiments of an actuatable toy provided with an entertainment device such as with a sound generating unit. Referring to FIGS. 5 and 6, a toy-actuatable toy 100 has a simple structure including a generally L-shaped body 102 and a sound generating unit 104. A base 106 of body 102 is provided with an opening 112 traversed by an actuator 116. The upper end of actuator 116 is coupled to an engagement unit 114, the other ends of actuator 116 is attached to a bell 118. The body preferably includes a raised area 111, such as perch, for landing by the bird. Thus, once the bird has landed on the perch, the bird can pick at the actuator, i.e. engagement unit attractively displayed in the base and also have the entertainment unit directly ahead.

The bird perched on base 106 can repeatedly lift engagement unit 104, which, in turn, displaces actuator 116 triggering the sound of bell 118. The toy 110 may be removably coupled to a cage by ribbed nut and washer system 28. Optionally, a side 108 of body 102 may be provided with a mirror 110.

In use, the bird may explore the toy and grab and lift engagement unit 114 located at a first location of the toy. This causes upward displacement of actuator 116 the lower end of which is coupled to bell 118 at a second. As the bell moves upwards, it starts generating a sound signal. However, to the bird, the intermediate base 106 may make it appear that the sound or other action is produced coincidently to the bird lifting engagement unit 114.

An actuatable toy 130 of FIGS. 7 and 8 is configured with an L-shaped body having a base 136 and a side 142. A sound generating unit includes an engagement unit 134 projecting above base 136 and configured to be repeatedly lifted by the caged bird.

A bell 138 is mounted to the top portion of side 142. An actuator 140 coupling engagement unit 134 and bell 138 has one end portion extending through base 136 and an intermediary portion extending along the outer surface of base 136 and further along the inner outer surface of side 142. The other end portion of actuator 140 traverses top portion of side 142 and is connected to bell 138.

The caged bird can entertain itself by repeatedly lifting engagement unit 134, which is, in turn, causes actuator 140 to move along a path defined by couplings 144 spaced apart along the outer surface of base 136 and side 142. As actuator 140 displaces, bell 138 generates a sound signal. However, to the bird, the distance between action and source of the sound or light etc. may make it appear that the sound or other action is produced coincidently to the bird lifting engagement unit 134.

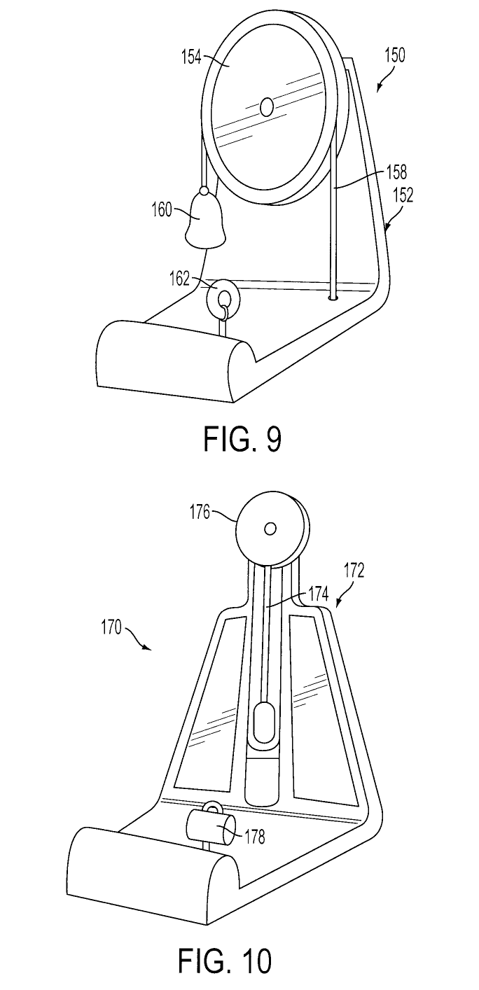

FIG. 9 illustrates a further modification of an actuatable toy 150. Configured with an L-shaped body 152, toy 150 is provided with a pulley 154 with a peripheral guide surface, which is shaped to receive an intermediary portion of a belt or actuator 158. In operation, the caged bird lifts an engagement unit 162 to displace belt 158 having its upper end coupled to and actuating a bell 160.

Turning to FIG. 10, an actuatable toy 170 is configured with a power bell entertaining unit. A bell 176 is mounted to a sidewall of a body 172 and configured to have one of the ends of an actuator 174 to trigger the sound during its displacement. The displacement of actuator 174 is caused by the bird lifting an engagement unit 178, which is located on the base of body 172.

In both of the above embodiments, the engagement unit and the entertaining effect are distant from each other. Thus, the bird perceives an indirect action and stays entertained and mentally engaged longer than by a direct action toy.

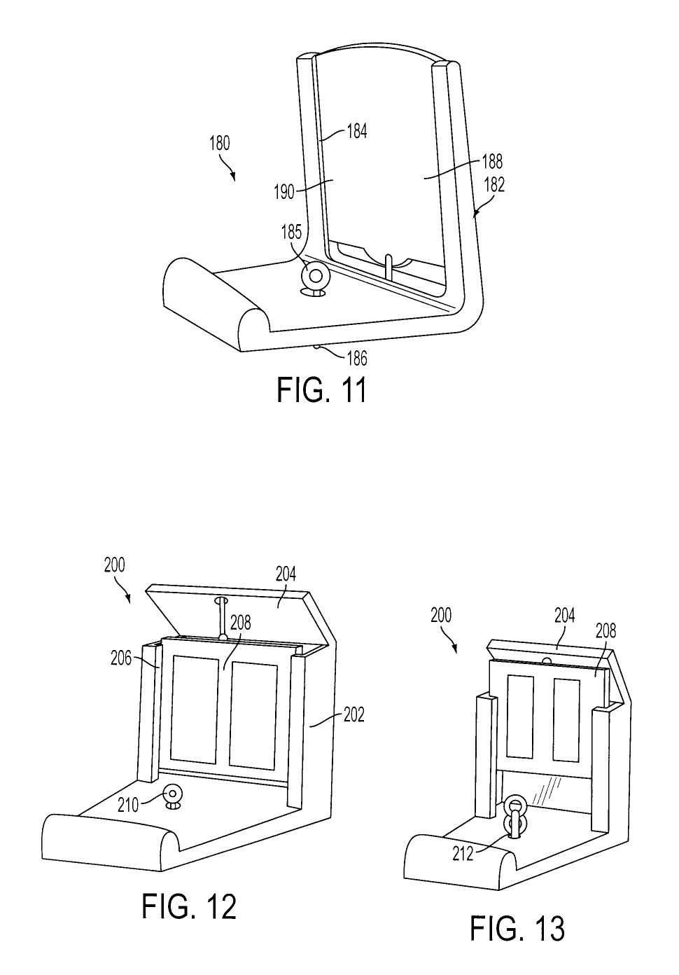

FIG. 11 illustrates an actuatable toy 180 operative to provide a visual effect. A body 182 of toy 180 is configured with an L-shaped cross-section and, thus, has a base and a side. The side of body 182 is provided with a frame 184 shaped and dimensioned to receive a mirror 188 guided in frame 184 in response to a pulling force which is applied by the bird to an engagement unit 185.

The engagement unit 185 is coupled to one end of an actuator 186 traversing the base of body 182 and having the opposite end coupled to the base of mirror 188. The bird may apply a pulling force to engagement unit 185 causing the engagement unit to move upwards and drag therewith actuator 186 so that the other end of the actuator applies a lifting force to the base of mirror 188 sufficient to displace the mirror upwards.

FIGS. 12 and 13 illustrate a further embodiment of an actuatable toy 200 with an entertainment device operative to provide a visual effect. The L-shaped body 202 has a top 204 angularly extending from the upper portion of the body's side forming an area to accommodate displacement of a frame 206. The side of body 202 is configured with the frame 206 guiding a double-mirror insert 208 in response to a pulling force applied an engagement unit 210 and coupled therewith by an actuator 212. The upper end portion of actuator 212 traverses a hole in top 204 and coupled to the upper end of double-mirror insert 208.

In the normal position, insert 208 is rested on the base of body 202, as shown in FIG. 12. Because of the pulling force, insert 208 can be displaced to a position shown in FIG. 13, in which top 204 prevent uncontrollable displacement of double-mirror insert 208.

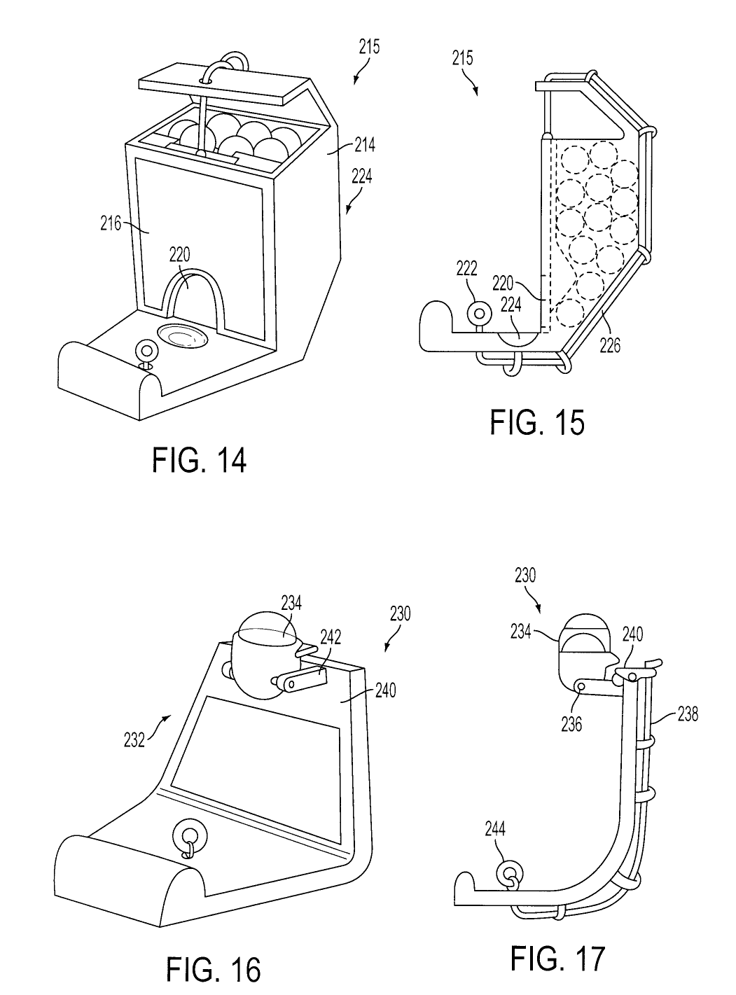

FIGS. 14 and 15 illustrate a further embodiment of an actuatable toy 215 operative to deliver treats that are stored in a box-like structure of a side 214 of body 224. The box is open at the top for inserting treats, food, toys, or the like that as further explained herein are suitably shaped to advance by gravity.

The side 214 is provided with a front face configured as a guide frame for a mirror 216 and having a bottom opening 220 normally covered from inside by mirror 216.

When the caged bird lifts an engagement unit 222 coupled to one end of the opposite ends of an actuator 226, the other end of actuator 226 applies a pulling force to the top portion of mirror 216, which slides upwards along the guide frame and opens opening 222. The treats run through the opening and accumulate in an indented region 224 formed in the base of body 224.

FIGS. 16 and 17 illustrate a further embodiment of an actuatable toy 230 provided with a treat-distributing cap 234. The cap 234 is pivotally mounted to a support bracket 236 mounted to a side 240 of a body 232. The supporting bracket 236 is configured, for example, with two spaced apart arms 242 pivotally supporting the opposite sidewalls of cap 234 by their respective front ends.

The bottom of cap 234 is coupled to a lever 240 rotatably mounted to the rear ends of supporting arms 242 and coupled to one of the opposite ends of an actuator 238. In use, the bird lifts an engagement unit 244 located next to the base of body 232 and causing the top end of actuator 238 to swing lever 240. Rotating, for example, counterclockwise, lever 240 tips cap 234 clockwise. As a result, a treat drops from cap 234 and falls on the base of body 232. Alternatively, the end of actuator 238 can be directly coupled to cap 234 and tip it so that the cap would drop a treat.

While the disclosed actuatable toy has been described in conjunction with specific embodiments, it is to be understood that many alternatives, modifications, and variations will be apparent to those skilled in the art in light of the foregoing description.

What is claimed is:

1. A toy actuatable by a bird, the toy comprising:
a perch for use by the bird;
a sound generating device;
a mounting unit coupling the perch and the sound generating device;
an engagement unit engageable by the bird;
an actuator operatively coupling the engagement unit and the sound generating device, the sound generating unit producing a sound signal in response engagement of the engagement unit by the bird.

2. The toy of claim 1, wherein the engagement unit and the sound generating device are disposed on opposing sides of the perch so that the bird may not easily perceive an interaction between the engagement unit and the sound generating device.

3. The toy of claim 1, wherein the mounting unit engages an end of the perch.

4. The toy of claim 3, wherein the mounting unit comprises a collar that shaped to surround the end of the perch.

5. The toy of claim 1, wherein the engagement unit is configured to be grabbed by the bird.

6. The toy of claim 1, wherein the mounting unit comprises a passage for movement of the actuator.

7. The toy of claim 1, wherein the sound generating device is a bell and the engagement unit comprises a ring for configured to be grabbed by a bird.

8. The toy of claim 1 further comprising an auxiliary entertainment unit mounted on the perch for amusing the bird.

9. The toy of claim 8, wherein the auxiliary entertainment unit and the sound generating device are disposed on opposing sides of the perch.

10. A toy actuatable by a bird, the toy comprising:
a body for holding an entertainment device for providing entertainment to the bird by providing an entertainment action;
an engagement unit displayed on the body;
an actuator coupling the engagement unit to the entertainment device for initiating the entertainment action when the engagement unit is engaged by the bird.

11. The toy of claim 10, wherein the engagement unit is disposed spaced-apart from the entertainment device, the actuator substantially hidden from the bird so that the bird may not easily perceive an interaction between the engagement unit and the entertainment device.

12. The toy of claim 10, wherein the body is substantially L-shaped and the engagement unit is disposed on a first leg of the L-shaped body.

13. The toy of claim 12, wherein the entertainment device is substantially disposed on a second leg of the L-shaped body.

14. The toy of claim 10, wherein the body comprises a raised area for standing by the bird.

15. The toy of claim 10, wherein the entertainment device comprises one of a sound effect and a visual effect.

16. The toy of claim 10, wherein the entertainment device comprises a bell.

17. The toy of claim 10, wherein the entertainment device comprises a mirror that is movable responsive to an engagement of the engagement unit by the bird.

18. The toy of claim 10, wherein the entertainment device comprises a storage for storing treats, the treat being dispensed from the storage responsive to an engagement of the engagement unit by the bird.

19. The toy of claim 18, wherein the storage tilts and dispenses the treat from the storage by gravity responsive to the engagement of the engagement unit by the bird.

20. A toy for a bird, the toy comprising:
a base;
an engagement unit for being pulled by the bird;
an entertainment device in view of the bird disposed distal from the engagement unit,
an actuator operatively connecting the engagement unit and the entertainment device so that the bird may not easily perceive an interaction between the engagement unit and the entertainment device.
